(19) United States
(12) Patent Application Publication
(10) Pub. No.: US 2017/0021461 A1
(43) Pub. Date: Jan. 26, 2017

(54) TUBE-PROFILE CUTTING MACHINE AND METHOD FOR CUTTING A CONTOUR

(71) Applicant: Mueller Opladen GmbH, Leverkusen (DE)

(72) Inventor: Ralf Hamacher, Bruehl (DE)

(21) Appl. No.: 15/139,816

(22) Filed: Apr. 27, 2016

Related U.S. Application Data
(63) Continuation of application No. PCT/EP2014/073584, filed on Nov. 3, 2014.

(30) Foreign Application Priority Data
Nov. 4, 2013 (DE) DE102013018417.7

(51) Int. Cl. B23K 37/053; B23K 26/08; B23K 26/38

(52) U.S. Cl. CPC B23K 37/053; B23K 26/38; B23K 26/0884; B23K 2201/06

(57) ABSTRACT

Tube-profile cutting machine having a cutting device and having a damping device by means of which a tube is clampable in a centered manner along a horizontally extending longitudinal axis and is rotatable about the longitudinal axis (5), having a chassis by means of which the tube and/or the cutting device are movable with respect to one another parallel to the longitudinal axis, having a vertical drive by means of which the cutting device is movable along a vertically extending vertical axis, having a rotary drive by means of which the cutting device is rotatable about the vertical axis, having a cutting head on the cutting device and having a pivot drive by means of which the cutting head is pivotable about a horizontal pivot axis, and having a feed drive by means of which the cutting head is feedable in a beam direction, wherein, by rotation of the clamping device and by means of the chassis, the vertical drive, the rotary drive, the pivot drive and the feed drive, the cutting head is movable with respect to the tube such that a cutting beam exiting the cutting head in the beam direction cuts a contour on the tube. Also disclosed is a method for cutting a contour by means of such a tube-profile cutting machine.

### RELATED APPLICATIONS

This application is a continuation of International application PCT/EP2014/073584 filed on Nov. 3, 2014 claiming priority from German Patent Application 10 2013 018 417.7 filed on Nov. 4, 2013 and U.S. provisional application 62/028, 620 filed on Jul. 19, 2014.

### FIELD OF THE INVENTION

The invention relates to a tube profile cubing machine.

### BACKGROUND OF THE INVENTION

Tube profile cutting machines and methods performed by the tube profile cutting machines of the general type recited supra are known from the product program of the applicant. Machines and methods of this type are used for automated contouring of tube spouts and containers for welding.

The typically cylindrical (tubular) containers are generally closed by cambered floors on one side or on both sides. Cambered floors are flattened relative to a semi spherical shape that is theorically ideal for pressure loading. DIN 28011 “Kloepperboden” and DIN 28013 “Korbbogenbboden” standarize various embodiments of such cambered floors.

Contours for tube connectors at cambered floors cannot be produced with the known tube profile cutting machines.

### BRIEF SUMMARY OF THE INVENTION

Thus, it is an object of the invention to cut a contour at a cambered floor for a container.

Improving upon a known tube cutting machine it is proposed according to the invention to provide a pivoting device by which the clamping device is pivotable by 90° so that a cambered floor for a pressure container with a vertically extending axis of symmetry is clampable by the clamping device in a centered manner and rotatable about the symmetry axis.

The object is achieved by a tube profile cutting machine including a cutting device, a clamping device by which a pipe is clampable centered about a horizontal longitudinal axis and rotatable about the horizontal longitudinal axis, a chassis by which the tube and/or the cutting device are movable parallel to the longitudinal axis and relative to one another, a vertical drive by which the cutting device is movable along a vertical axis, a rotary drive by which the cutting device is rotatable about the vertical axis, a cutting head arranged at the cutting device, a pivot drive by which the cutting head is pivotable about a horizontal pivot axis, and a feed drive by which the cutting head is feedable in a beam direction, wherein the cutting head is movable relative to the tube by the chassis, the vertical drive, the rotary drive, the pivot drive and the feed drive so that a cutting beam extiting from the cutting head in the beam direction cuts a contour at the tube.

The object is also achieved by a method for cutting a profile, wherein at a tube profile cutting machine including a cutting device, a clamping device by which a pipe is clampable centered about a horizontal longitudinal axis and rotatable about the horizontal longitudinal axis, a chassis by which the tube and/or the cutting device are movable parallel to the longitudinal axis and relative to one another, a vertical drive by which the cutting device is movable along a vertical axis, a rotary drive by which the cutting device is rotatable about the vertical axis, a cutting head arranged at the cutting device, a pivot drive by which the cutting head is pivotable about a horizontal pivot axis, a feed drive by which the cutting head is feedable in a beam direction.

The cutting device of a known tube profile cutting machine is configured for cutting contours about a vertical axis and limited to such contours due to a limited pivot range. The tube profile cutting machine according to the invention facilitates clamping cambered floors in a manner which facilitates using the known cutting device of the known tube profile cutting machine for cutting contours in cambered floors of this type.

Advantageously the pivot device of the tube profile cutting machine according to the invention includes a pivot joint with a horizontally extending pivot axis. A tube profile cutting machine of this type according to the invention facilitates reproducible pivoting of a clamping device that may weigh up to several tons depending on the application. Alternatively the clamping device can be removed from the standard arrangement for clamping tubes that are lying fiat using a crane. Then the clamping device is pivoted by 90° and inserted again.

Based on the known method it is proposed according to the invention that the clamping device is pivoted by 90° using a pivot device, that a cambered floor for a container with a vertically extending axis of symmetry is damped in a centered manner using the clamping device and the cambered floor is rotated about the axis of symmetry and the cutting head is moved by the chassis, the vertical drive, the rotary drive, the pivot drive and the feed drive relative to the cambered floor so that a cutting beam exiting in a beam direction from the cutting head cuts the contour at the cambered floor. A method of this type according to the invention is executable using the tube profile cutting machine according to the invention and is characterized by the advantages recited supra.

### BRIEF DESCRIPTION OF THE DRAWINGS

The invention is subsequently is described based on an embodiment with reference to drawing figures, wherein:

FIG. 1 illustrates a tube profile cutting machine according to the invention cutting a contour at a tube;

FIG. 2A illustrates the tube profile cutting machine according to the invention cutting a contour at a cambered floor;

FIG. 2B illustrates details of the preceding FIGs;

FIG. 2C illustrates details of FIG. 1 and FIG. 2A.

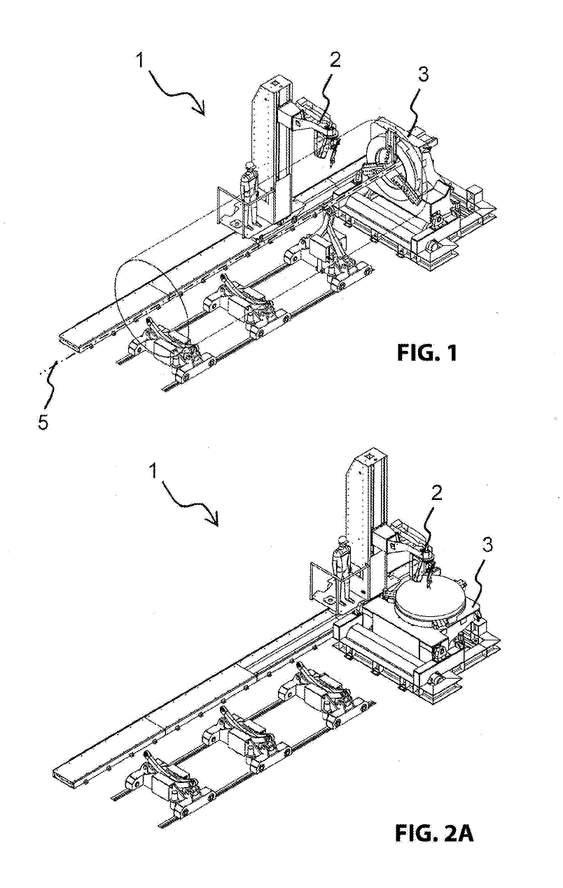

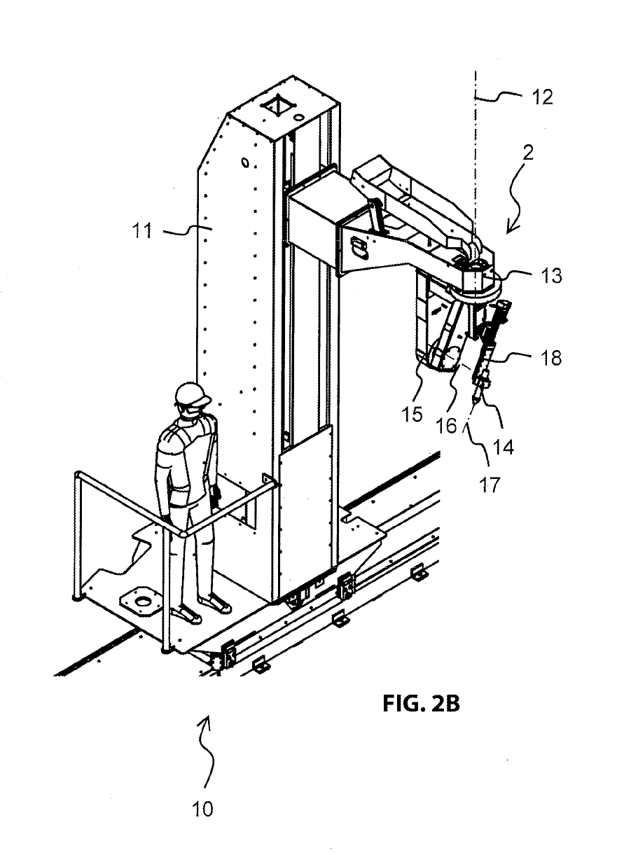

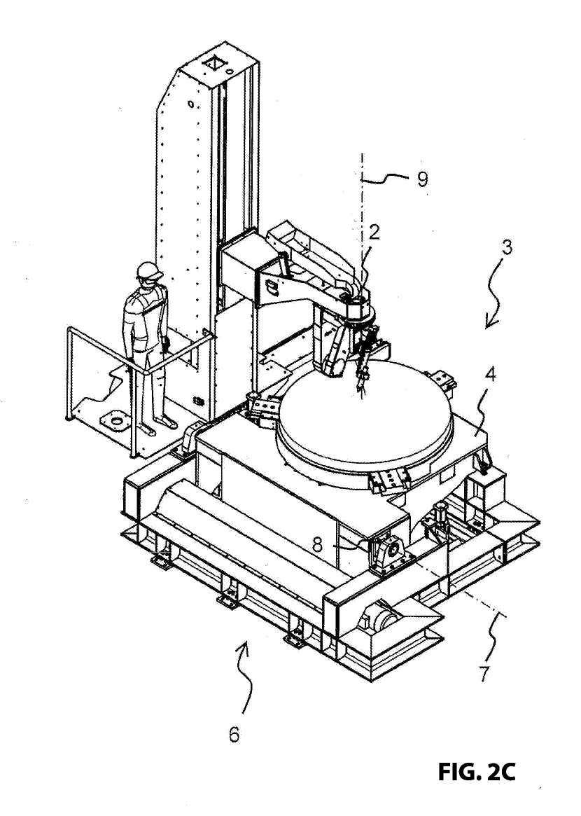

### DETAILED DESCRIPTION OF THE INVENTION

The illustrated tube profile cutting machine 1 according to the invention includes a cutting device 2 and a clamping device 3. The clamping device 3 is fixated in place on a base that is not illustrated and includes a three jaw clamping chuck 4.

The clamping chuck 4 has an interior diameter of 1200 mm and an exterior diameter of 2500 mm and thus facilitates clamping tubes centered relative to a longitudinal axis 5 wherein an exterior diameter of the tubes is smaller than 1200 mm or an exterior diameter of the tubes is greater than 2500 mm.

The clamping chuck 4 is pivotable by a pivoting device 6 about a horizontally extending pivot axis 7 of a pivot joint 8 by 90° and thus rotatable about the longitudinal axis 5 for machining tubes and rotatable about the vertically extending symmetry axis 9 for machining cambered floors.

The cutting device 2 is movable by the chassis 10 parallel to the longitudinal axis 5 and movable by a vertical drive 11 along a vertical axis 12 and rotatable by 360° about the vertical axis 12 by a rotary drive 13.

A cutting head 14 (a blow torch) arranged at the cutting device 2 is pivotable by a pivot drive 15 about a horizontal pivot axis 16 by 70° from vertical, From the cutting head 14 a non illustrated burning beam is orientable in a beam direction 17 towards the tube or the cambered floor. The cutting head 14 is feedable by a feed drive 18 in the beam direction 17.

The controlled axes are motion coordinated with each other during the cutting process and facilitate exact positioning of the work piece relative to the cutting head 14. All controlled axes are configured with non illustrated AC-servo drives and controllers.

A laser sensor that is not illustrated continuously controls a distance of the cutting head 14 from a surface of the work piece.

### REFERENCE NUMERALS AND DESIGNATIONS

1 tube profile cutting machine

2 cutting device

3 clamping device

4 damping chuck

5 longitudinal axis

6 pivot device

7 pivot axis

8 pivot joint

9 symmetry axis

10 chassis

11 vertical drive

12 vertical axis

13 rotary drive

14 cutting head

15 pivot drive

16 pivot axis

17 beam direction

18 feed drive

What is claimed is:

1. A tube profile cutting machine, comprising:
a cutting device;
a clamping device by which a tube is clampable centered about a horizontal longitudinal axis and rotatable about the horizontal longitudinal axis,
a chassis by which the tube or the cutting device are movable parallel to the horizontal longitudinal axis and relative to one another:
a vertical drive by which the cutting device is movable along a vertical axis;
a rotary drive by which the cutting device is rotatable about the vertical axis;
a cutting head arranged at the cutting device;
a pivot drive by which the cutting head is pivotable about a horizontal pivot axis; and
a feed drive by which the cutting head is feedable in a beam direction,
wherein the cutting head is movable relative to the tube by the chassis, the vertical drive, the rotary drive, the pivot drive and the feed drive so that a cutting beam extiting from the cutting head in the beam direction cuts a contour at the tube,
characterized by a pivot device by which the clamping device pivotable by 90° so that a cambered floor for a container with a vertical axis of symmetry is clampable in a centered manner and rotatable about the vertical axis of symmetry.

2. The tube profile cutting machine according to claim
characterized in that the pivot device includes a pivot joint with a horizontally extending pivot axis.

3. A method for cutting a profile,
wherein at a tube profile cutting machine including
a cutting device,
a clamping device by which a tube is clampable centered about a horizontal longitudinal axis and rotatable about the horizontal longitudinal axis;
a chassis by which the tube and/or the cutting device are movable parallel to the horizontal longitudinal axis and relative to one another,
a vertical drive by which the cutting device is movable along a vertical axis,
a rotary dove by which the cutting device is rotatable about the vertical axis;
a cutting head arranged at the cutting device,
a pivot drive by which the cutting head is pivotable about a horizontal pivot axis,
a feed drive by which the cutting head is feedable in a beam direction;
performs the steps:
pivoting the clamping device by a pivot device by 90°;
clamping a cambered floor for a container with a vertical axis of symmetry in a centered manner and rotating the cambered floor for the container about the axis of symmetry,
moving the cutting head relative to the cambered floor by the chassis, the vertical drive, the rotary drive, the pivot drive and the feed drive, and
cutting a countour at the cambered floor with a cutting beam that extits from the cutting head in the beam direction.

4. A tube profile cutting machine, comprising:
a cutting device;
a clamping device by which a tube is clampable centered about a horizontal longitudinal axis and rotatable about the horizontal longitudinal axis;
a chassis by which the tube and the cutting device are movable parallel to the horizontal longitudinal axis and relative to one another;
a vertical drive by which the cutting device is movable along a vertical axis;
a rotary drive by which the cutting device is rotatable about the vertical axis
a cutting head arranged at the cutting device;
a pivot dove by which the cutting head is pivotable about a horizontal pivot axis; and
a feed drive by which the cutting head is feedable in a beam direction,
wherein the cutting head is movable relative to the tube by the chassis, the vertical drive, the rotary drive, the pivot drive and the feed drive so that a cutting beam extiting from the cutting head in the beam direction cuts a contour at the tube,
characterized by a pivot device by which the clamping device pivotable by 90° so that a cambered floor for a container with a vertical axis of symmetry is clampable in a centered manner and rotatable about the vertical axis of symmetry.
